(19) United States
(12) Patent Application Publication
(10) Pub. No.: US 2014/0067669 A1
(43) Pub. Date: Mar. 6, 2014

(54) Methods and Systems for Managing Communication Streams

(71) Applicants: Todd Meeks, Cincinnati, OH (US); Scott Metz, New Berlin, WI (US); Giri Narayanan, Cincinnati, OH (US); Rajendra Thota, Cold Spring, KY (US); Christina Carter, Forney, TX (US); Saurabh Gaba, Gurgaon (IN); Milan Shah, Plano, TX (US); Griselda Palaniswamy, Irving, TX (US); Jit Sen, Irving, TX (US)

(72) Inventors: Todd Meeks, Cincinnati, OH (US); Scott Metz, New Berlin, WI (US); Giri Narayanan, Cincinnati, OH (US); Rajendra Thota, Cold Spring, KY (US); Christina Carter, Forney, TX (US); Saurabh Gaba, Gurgaon (IN); Milan Shah, Plano, TX (US); Griselda Palaniswamy, Irving, TX (US); Jit Sen, Irving, TX (US)

(73) Assignee: CITICORP DEVELOPMENT CENTER, INC., Cincinnati, OH (US)

(21) Appl. No.: 13/600,624

(22) Filed: Aug. 31, 2012

(51) Int. Cl. G06Q 20/32; G06Q 20/40; H04W 4/14

(52) U.S. Cl. 705/44; 455/466; 705/39

(57) ABSTRACT

Methods and systems for managing communication streams from multiple sources while utilizing a single short code employ a processor coupled to memory and other computer hardware and software components for establishing at least one conversation session with an outbound message to a recipient and defining a lifespan of the outbound message of the at least one conversation session. At least one reply to a response from the recipient to the outbound message of the at least one conversation session is delivered during the lifespan of the outbound message of the at least one conversation session.

### FIELD OF THE INVENTION

The present invention relates generally to the field of electronic communications, and more particularly to methods and systems for managing communication streams from multiple sources while utilizing a single short code.

### BACKGROUND OF THE INVENTION

Typically, most text messaging implementations require a separate short code to be purchased for each function that interacts with the customers of a business entity so that customer responses may be appropriately guided when received by the business entity. The cost associated with each short code may be significant, and the cost associated with separate short codes for each of multiple functions may be quite high.

There is a present need for methods and systems for managing communication streams from multiple sources while utilizing a single short code that address and overcome the problems of existing text messaging implementations which require separate short codes for each of multiple functions.

### SUMMARY OF THE INVENTION

Embodiments of the invention employ computer hardware and software, including, without limitation, one or more processors coupled to memory and non-transitory computer-readable storage media with one or more executable programs stored thereon which instruct the processors to perform the methods and systems for managing communication streams from multiple sources while utilizing a single short code described herein.

Embodiments of the invention may provide methods for managing communication streams from multiple sources while utilizing a single short code that involve, for example, establishing, using a processor coupled to memory, at least one conversation session with an outbound message to a recipient; defining, using the processor, a lifespan of the outbound message of the at least one conversation session; and delivering, using the processor, at least one reply to a response from the recipient to the outbound message of the at least one conversation session during the lifespan of the outbound message of the at least one conversation session.

Embodiments of the invention may further involve, for example, establishing an outbound communication state for the at least one conversation session. In addition, defining the lifespan of the outbound message may involve defining a period of time within which information in the outbound message is relevant. Delivering the at least one reply to the response may also involve, for example, delivering a default reply to the response to the outbound message of the at least one conversation session after the lifespan of the outbound message of the at least one conversation session.

Aspects of embodiments of the invention may additionally involve, for example, establishing a plurality of conversation sessions, each with an outbound message to said recipient, and an outbound communication state for each of the plurality of conversation sessions. Other aspects may involve, for example, tracking the last established one of the outbound communication states. In such aspects, tracking the last established one of the outbound communication states may involve establishing an outbound communication state of a last one of the outbound conversation sessions and breaking an outbound communication state of a preceding conversation session.

Additional aspects of embodiments of the invention may involve, for example, delivering the reply to the response to the outbound message based upon a source of the last established one of the outbound communication states. In further aspects of embodiments of the invention, establishing the plurality of conversation sessions may also involve establishing a plurality of concurrent conversation sessions with the recipient and a concurrent outbound communication state for each of the plurality of concurrent conversation sessions. Aspects of the invention may also involve, for example, delivering the reply to the response to the outbound message of one of the plurality of concurrent conversation sessions during the lifespan of all of the outbound messages of the plurality of concurrent conversation sessions with a request for a further response indicating a choice by the recipient of one of the plurality of concurrent conversation sessions to which the response to the outbound message relates.

Further aspects of the invention may involve, for example, identifying by an interface with a payment utility an account utilized by said recipient for a previous payment via the payment utility. Such aspect may involve, for example, establishing the at least one conversation session with the outbound message to the recipient inviting the recipient to authorize a current payment from the identified account via the payment utility. This aspect may also involve, for example, receiving a response from the recipient to the outbound message authorizing the current payment from the identified account via the payment utility, and processing the current payment by the interface to the payment utility. Such aspect may further involve, for example, delivering the at least one reply to the response to the outbound message of the at least one conversation session confirming the current payment.

In other aspects of the invention, establishing the at least one conversation session may further involve, for example, establishing at least one conversation session with the outbound message to the recipient requesting the recipient to authenticate a financial transaction. Such other aspects may also involve, for example, receiving a response to the outbound message authenticating the financial transaction. In such other aspects, delivering the at least one reply may further involve, for example, delivering the at least one reply to the response to the outbound message of the at least one conversation session authorizing the financial transaction

Other embodiments of the invention may provide systems for managing communication streams from multiple sources while utilizing a single short code utilizing, for example, a processor coupled to memory, the processor being programmed to establish at least one conversation session with an outbound message to a recipient; define a lifespan of the outbound message of the at least one conversation session; and deliver at least one reply to a response to the outbound message of the at least one conversation session during the lifespan of the outbound message of the conversation session.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

### BRIEF DESCRIPTION OF THE DRAWINGS

FIG. 1 is a schematic diagram that illustrates an overview example of components and the flow of information between components for a communication system according to embodiments of the invention; and

FIG. 2 is a flow chart which illustrates an example of the process of sending an outbound message to a recipient for embodiments of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used in another embodiment to yield a still further embodiment. Thus, it is intended that the present invention cover such modifications and variations that come within the scope of the invention.

Embodiments of the invention provide methods and systems for managing communication streams from multiple sources while utilizing a single short code. An application for embodiments of the invention may enable interactive communication via text between an entity, such as a financial institution, and its customers. Key aspects of functionality with the application for embodiments of the invention may include, for example, an ability to maintain a conversation state with a customer and an ability for the application to facilitate payments through text messaging.

Components within the application for embodiments of the invention may utilize an extension of a concept of an application server session to establish a conversation session with a customer, which allows for key functionality. One such key functionality makes it possible for an application administrator to define a lifespan of an outbound text message, which translates to a period of time that the information within the text message is relevant. This enables appropriate responses to be delivered to a customer while an outbound text message is live, or a default response to be delivered if the text message is outside of its lifespan, because the conversation state is being maintained with the customer.

Further, with the conversation session establishing state with the customer, tracking of which outbound text messages are active by source is also enabled according to embodiments of the invention. By combining the conversation state with the text message life span, embodiments of the invention enable the management of communication streams from multiple sources while utilizing a single short code.

There are a number of scenarios for utilization of the capabilities of embodiments of the invention. Because of the serial nature of text communications, an individual may only realistically respond to a last text message received by the individual. However, in one scenario, embodiments of the invention make it possible to track a last outbound communication state that was established and in turn to answer a customer's text response with an appropriate reply based upon the configuration of the source that created that last outbound communication state.

Assume, for example, that a financial institution's cards and mortgages lines of business both initiate an outbound text to the same customer, with the cards business creating the last outbound text. Assume further that the customer responds with a message, such as “HELP”. In the tracking scenario, embodiments of the invention enable the financial institution to reply with the cards business text.

In another scenario in which multiple sources within the business entity have established a conversation state with the same customer and all of their text messages are within their respective lifespans, embodiments of the invention enable the financial institution to respond to the customer with options. Assume, for example, that the financial institution's cards and mortgages businesses both initiated outbound text messages to the same customer at the same time. In this scenario, the financial institution may reply to the customer with a request for the customer to choose the particular communication to which the customer is responding. For example, the customer may be instructed to send “Respond 1 for cards” or “Respond 2 for mortgages”, so that the customer may receive an appropriate reply, for example, to the customer's “HELP” response.

Another capability of the application for embodiments of the invention is to facilitate payments via text messaging. For example, the financial institution may establish an interface with a global payment utility (GPU) of the financial institution to enable the payments via text messaging functionality. In order to address an issue of lack of security in text messaging, the interface may pre-screen customers who are prospective recipients of outbound text messages to see if they have previously utilized the GPU functionality for a payment.

If a prospective recipient who previously utilized the GPU functionality for a payment is identified, that means that the financial institution has a valid bank account on file for the customer. In such case, an outbound message may be dynamically configured to notify the customer that the financial institution can accept a payment from the customer's bank account. The customer may then accept the terms of payment, including an amount, or the customer may respond with a different amount to pay. When a positive response is received from the customer, the interface to the GPU may be utilized to process the payment, and a verification text may be sent to the customer with the results of the transaction.

Referring again to the example in which the financial institution's cards and mortgages lines of business both initiate an outbound text to the same customer, with cards creating the last outbound text, the last text message that appears on the customer's mobile device is from the cards business. Because of the serial nature of text messaging, when the customer responds, the response is to the cards text message. Further, the only available response may be, for example, “HELP” because that is what may be included in the text message.

In existing implementations, the cards and mortgages lines of business may use different, unique short codes, so that when a customer responds to a text message from either with “HELP”, the response would be guided to the appropriate business based upon the unique short code to which the customer responds. However, in embodiments of the invention in which both the cards and mortgages business use the same short code, when a customer responds “HELP”, it may be known that the cards business was the last business unit to establish state with that customer, and the “HELP” response may be guided to the cards business.

In the tracking aspect of embodiments of the invention, when an outbound message occurs, an internal database may track the source of the message and its state may be established. In one aspect, when the second outbound text message is sent, the financial institution may break or kill the previous state that was established, for example, by the mortgages line of business and establish a state of conversation with the cards line of business. In that aspect, only one active state may be established from the last business to send an outbound message. Thus, when the customer responds with a “HELP” message, it is known that the cards business was the last business to establish the state, and the financial institution may respond with a help reply based upon the cards business because replies from the two different businesses are necessarily different.

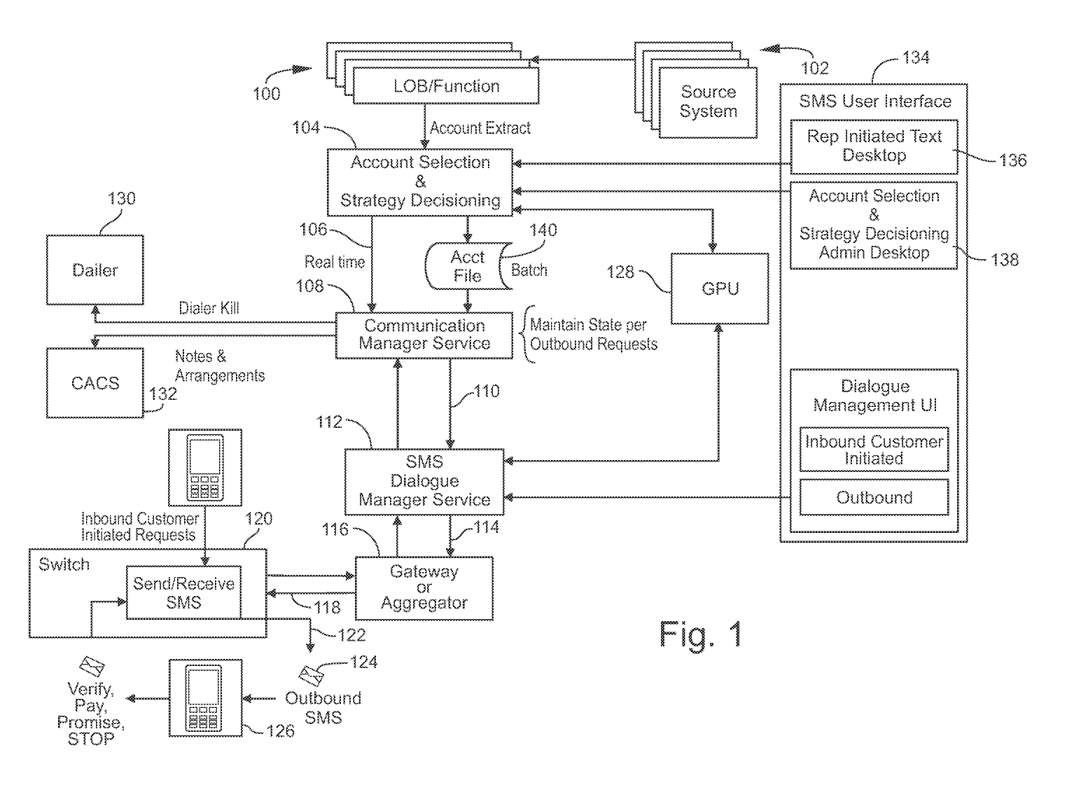

FIG. 1 is a schematic diagram that illustrates an overview example of components and the flow of information between components for a communication system according to embodiments of the invention. Referring to FIG. 1, embodiments of the invention may involve multiple lines of business 100, one of which may be the mortgages business. Assume, for example, that the first line of business that sends an outbound message is the mortgages business. In that case, a group of customers to receive the text message may be retrieved for the mortgages business from a source system 102. An account selection and strategy decisioning function 104 for embodiments of the invention may include, for example, business rules built around who qualifies to receive a text message. Assume, for simplicity, that only one person qualifies to receive the text message from the mortgages business. Thus, computer logic of the account selection strategies function 104 may determine that only one customer is going to receive the text message from the mortgages business. Thereupon, a file may be created regarding the text message to that one customer from the mortgages business and may be sent at 106 to a communication manager service function 108 for embodiments of the invention at which the state is established.

It may be known at the communication manager service function 108 that the mortgages business will send a text message to the particular customer. Therefore, the communication manager service function 108 may send at 110 a request to a dialogue manager service function 112 that maintains the information that the financial institution wants to tell the customer. In this case, the mortgages business of the financial institution may want to tell the customer that his or her mortgage is delinquent. A template code may also be sent by the communication manager service function 108 to the dialogue manager service function 112 which translates, for example, to “Your mortgage is delinquent.” The dialogue manager service function 112 for embodiments of the invention may then send the request at 114 through a gateway or an aggregator 116, which in turn may at 118 send the request to a telecommunications provider 120. Upon receiving the request, the telecommunications provider 120 may at 122 send the requested text message 124 to the customer's mobile device 126.

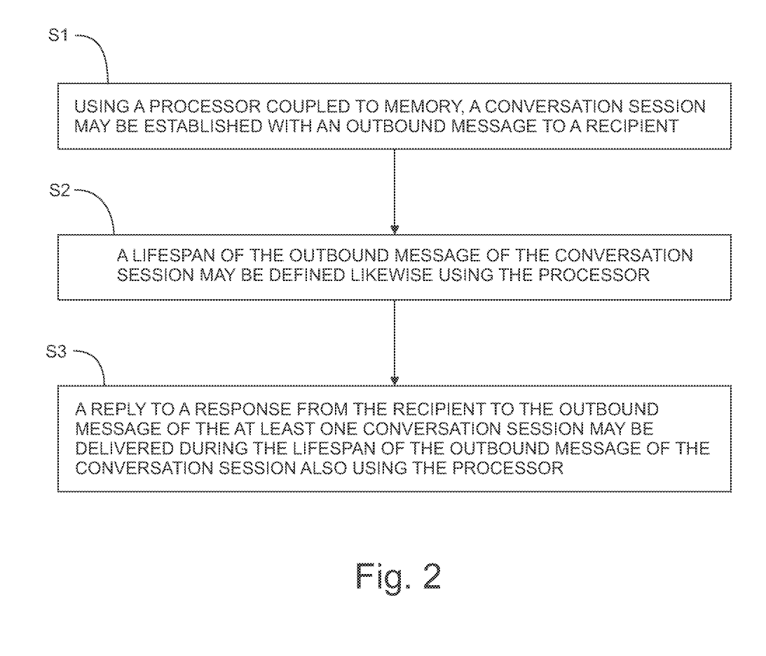

FIG. 2 is a flow chart which illustrates an example of the process of sending an outbound message to a recipient for embodiments of the invention. Referring to FIG. 2, at S1, using a processor coupled to memory, a conversation session may be established with an outbound message to a recipient. At S2, a lifespan of the outbound message of the conversation session may be defined likewise using the processor. At S3, a reply to a response from the recipient to the outbound message of the at least one conversation session may be delivered during the lifespan of the outbound message of the conversation session also using the processor.

Returning to the example of sending the outbound message for the mortgages business, assume that within a short period of time, such as a minute or a few minutes, after sending the mortgages business text message to the customer, the cards business may proceed with the same process to send a text message to the same customer using the same short code. Likewise, the cards business of the multiple lines of business function 100 may pull in the group of customers for the cards business from the source system 102. Assume that the account selection and strategy decisioning function 104 likewise decides that only the particular customer, who also has a delinquent card account, qualifies to receive the text message from the cards business. The process of the second text message may be generally the same as with the first text message. The process for embodiments of the invention may go through similar strategy decisioning, and in the second text message, it may be that the cards business wants to send a text message to the particular customer, such as “Your card account is delinquent”. Thus, computer logic of the account selection strategies function 104 may determine that only the particular customer is going to receive the text message from the cards business. Thereupon, a file may be created regarding the text message to the customer from the cards business and likewise sent to the communication manager service function 108.

At this point, the communication manager service function 108 may recognize that the text message is for the same customer with the same short code and is thus a new request for the same customer. Therefore, the communication manager service function 108 may break the state that was established for the mortgages business text message to the same customer and may establish a state of communication for the cards business text message to the same customer. The communication manager service function 108 may then send a request to the dialogue manager service function 112 that maintains the information the financial institution wants to tell the customer which in this case is that his or her card account is delinquent. A template code may be sent to the dialogue manager service function 112 that translates, for example, to “Your cards account is delinquent”. The dialogue manager service function 112 may then send the request through the gateway or an aggregator 116. The gateway or aggregator 116 may in turn send the request to the telecommunications provider 120, which sends the requested text message to the customer's mobile device 126.

As a result, the particular customer's mobile device 126 may display two text messages, the first of which is from the mortgages business and the second of which is from the cards business, both informing the customer that he or she is delinquent. The text message may also say, for example, “If you don't understand just respond ‘HELP’”. The customer may look at his or her mobile device 126 and see that the last text message is from the cards business. Realizing that theoretically he or she can respond only to the last text message, the customer may simply respond with “HELP”.

When the customer's response is received by the dialogue manager service 112 via the switch 120 and the gateway 116, the dialogue manager service 112 may determine the latest state of conversation through a call to the communication manager service function 108. Based upon the last state being established by the cards business, it may be determined that the last text message was sent to the customer by the cards business. It may be further determined that a “HELP” reply message associated with the cards business should be sent to the customer. A template code may be sent to the dialogue manager service function 112 which may translate to an appropriate cards business line reply message that may be sent to the customer's mobile device 126 via the gateway or aggregator 116 and the telecommunications provider 120.

An aspect of embodiments of the invention may involve, for example, a respond-with-options alternative. The respond-with-options alternative enables the customer to respond to any text message that he or she receives from a business of the financial institution, regardless of whether such message was the last text message received. Referring further to FIG. 1, assume, for example, that a customer receives a first text message on his or her mobile device 126 from the financial institution's mortgage line of business and a second text message on the mobile device 126 from the financial institution's cards line of business a minute of so later.

When the customer responds with “HELP”, the response may be received by the dialogue manager service function 112, which may call the communication manager service 108 with a request for the identity of the business which established the state with the particular customer. In the respond-with-options alternative, the communication manager service 108 may send a reply to the dialogue manager service 112, such as “The lifespan of both of those text messages is three days; they are both within their lifespan; and we have one message that came from mortgages and one message that came from cards.” Thereupon, the dialogue manager service 112 may dynamically create and send a clarification reply to the customer's mobile device 126, such as “Would you like help concerning your mortgage account or your cards account? Send 1 for mortgage or send 2 for cards.” If the customer sends back a “1” message, the dialogue manager service 112 may then associate the customer's previously received “HELP” response with the outbound text message from the mortgage line of business, and send an appropriate mortgages business line help reply to the customer.

Referring again to FIG. 1, in embodiments of the invention, the GPU 128 may be employed in processing customer payments by text messages. In the customer payments-by-text messages aspect, the process may be the same except the strategy decisioning process 104 may call to the GPU 128 and receive information that the customer previously used a financial institution account to make a payment through the GPU 128. Thereupon, a file may be dynamically created regarding a text message to the customer saying, for example, “Your account is $50 past due. We can process a payment utilizing account number XXXX1234 if you would like us to. Would you like to use that account and make this payment?”

In the customer payments-by-text messages aspect, a file may be sent via the communications manager service 108 to the dialogue manager service 112 which may send the text message to the customer's mobile device 126 via the gateway or aggregator 116 and telecommunications switch 120. Upon receiving the text message, the customer may respond by sending “YES” in a text message response. Since the financial institution previously established the customer's financial institution account number, the payment may be processed by the financial institution automatically through text messaging.

Thus, the payments-by-text messages aspect of embodiments of the invention overcomes significant issues currently prevalent in the industry concerning the inherent insecurity of any type of payment made via text message. For example, it would be unwise for a financial institution to send a text message to a customer to say the customer's cards account is $50 past due and to request an account number and verification for payment, because a response message from the customer could be easily intercepted. That security issue is overcome by embodiments of the invention by utilizing a previously used account and then sending the customer only information that would not be useful to a criminal. Because the financial institution has the customer's previously used account information stored internally, a payment may be processed through text messaging.

Embodiments of the invention may also involve a dialer and a collection aspect. For example, referring to FIG. 1, when it is decided that a customer is delinquent and that an attempt will be made to contact the customer through various means, a request may be sent to the dialer function 130 to arrange, for example, for a representative to talk to the customer by phone, as well as for a text message to be sent to the customer. Assume that the text message is thereafter sent to the customer who brings his or her account current by making a text message payment. However, the record for having the representative to call the customer may still be in place at the dialer function 130. Therefore, after the customer's account becomes current, a record may be sent by the communications manager service function 108 to the dialer 130 to cancel the call to the customer because the delinquency is resolved.

Referring again to FIG. 1, a record may be sent by the communication manager service 108 to a collection system 132 of the occurrence of a communication to the customer and payment by the customer. A notes component of the collection system 132 may store a record, for example, of the text message communication to the customer and may be updated from time to time. The collection system 132 manages the collection process and allows a continuation of whatever may have resulted from the last communication with the customer.

Referring once again to FIG. 1, a short message service user interface aspect 134 may include, for example, computer terminals 136, 138 coupled to the account selections and strategy decisioning function 104 and the dialogue management service function 112. For example, a representative at a desktop 136 may have a phone conversation with the customer during which the customer says, “I'll make a payment”. The representative may then reply, “Would you like me to send you a text message with a receipt for the payment?” Assuming that the customer answers “Yes”, the representative may enter a request on the laptop 136 to have a text message sent to the customer's phone number with the message, “Thank you for your payment.” The request may then be sent to the account selection and strategy decisioning function 104 and follow the same process to the customer's phone 120 via the communication manager service 108, the dialogue manager service 112, the gateway or aggregator 116 and the telecommunications switch 120.

It is to be noted that the flow of information between the account selection and strategy decisioning function 104 and the communication manager service function 106 may be in batches of account files 140 or in real time 106. The real time flow of information 106 may relate, for example, to initiation of a text message to a customer by a representative using the desktop 136. The account selection and strategy decisioning admin desktop 138 allows an administrator to communicate with the account selection and strategy decisioning function 104. For example, when the source system 102 retrieves a file to go to the account selection strategy decisioning function 104, an administrator may enter a request, for example, for text messages to all customers who are 30-60 days past due and have a balance greater than $300. Based upon that criteria, the source system 102 may send all customers to the account selection function 104 which may filter out customers to whom the financial institution does not want to send the text message. The text message may then be created for all customers who meet the criteria entered by the administrator at the desktop 138.

Embodiments of the invention may also involve an inbound customer initiated aspect. In this aspect, for example, the financial institution may send a billing statement to its customers that invites the customers to send a text message using a particular short code number if they want to contact the financial institution about a matter, such as a mortgage. When such text messages are received, they are sent to the dialogue manager service function 112 which calls the communication manager service 108 to determine whether it had established a conversation state with the particular customer. The communication manager service 108 may then notify the dialogue manager service 112 that no conversation state was established and that the text message was initiated completely by the customer. In the absence of a conversation state, the dialogue service manager 112 may access a marketing database of marketing campaigns to see if there is a match for “mortgage deal”. If so, a text message may be sent to the customer regarding a mortgage deal aspect. As previously noted, the communication manager service 108 sends template codes to the dialogue manager service 112, and the dialogue manager service 112 translates the template code into predetermined verbiage for the text message.

It is to be noted that embodiments of the invention may be utilized in connection, for example, with many different functions including, without limitation, marketing, customer service, collections, etc. In any such function, the process flows and functionalities in managing responses to delinquency or collections text messages may be similar to the process flows and functionalities in managing responses to text messages sent to customers inviting then to apply for a new credit card or borrow money. For example, the mortgage and cards businesses of the financial institution may continue to use the same short message code for their respective promotional and advertising text messages to customers.

Another aspect of embodiments of the invention may involve, for example, a fraud management source system. For example, assume a customer at a store swipes his or her credit card at the merchant's point-of-sale terminal to make a payment. As part of the authorization process, a request may be sent to a fraud component of the source system 102. In such case, if the cardholder is flagged as potentially fraudulent, the transaction may be denied. In embodiments of the invention, the fraud management system may send a request in real time through the same process flows and functionalities as used in managing responses to delinquency or collections text messages, except the text message template code may translated into a request for the customer to confirm that he or she is at the merchant's point-of-sale making the payment.

If the customer responds by sending a response, such as “YES”, the message may proceed back through the same process and functionality to the fraud management component of the source system 102, whereupon the transaction may be approved. In the fraud management aspect, the mortgages business and the fraud management system may use the same short codes. Thus, the mortgages business may send a text message to the same customer using the same short code used earlier in the same day. Accordingly, when the “YES” response to the fraud text message is received, it may be confirmed that the fraud-related text message has the latest state established for conversation and that the “YES” response means that it is a valid transaction.

It is to be understood that embodiments of the invention may be implemented as processes of a computer program product, each process of which is operable on one or more processors either alone on a single physical platform, such as a personal computer, or across a plurality of platforms, such as a system or network, including networks such as the Internet, an intranet, a WAN, a LAN, a cellular network, or any other suitable network. Embodiments of the invention may employ client devices that may each comprise a computer-readable medium, including but not limited to, random access memory (RAM) coupled to a processor. The processor may execute computer-executable program instructions stored in memory. Such processors may include, but are not limited to, a microprocessor, an application specific integrated circuit (ASIC), and or state machines. Such processors may comprise, or may be in communication with, media, such as computer-readable media, which stores instructions that, when executed by the processor, cause the processor to perform one or more of the steps described herein.

It is also to be understood that such computer-readable media may include, but are not limited to, electronic, optical, magnetic, RFID, or other storage or transmission device capable of providing a processor with computer-readable instructions. Other examples of suitable media include, but are not limited to, CD-ROM, DVD, magnetic disk, memory chip, ROM, RAM, ASIC, a configured processor, optical media, magnetic media, or any other suitable medium from which a computer processor can read instructions. Embodiments of the invention may employ other forms of such computer-readable media to transmit or carry instructions to a computer, including a router, private or public network, or other transmission device or channel, both wired or wireless. Such instructions may comprise code from any suitable computer programming language including, without limitation, C, C++, C#, Visual Basic, Java, Python, Perl, and JavaScript.

It is to be further understood that client devices that may be employed by embodiments of the invention may also comprise a number of external or internal devices, such as a mouse, a CD-ROM, DVD, keyboard, display, or other input or output devices. In general such client devices may be any suitable type of processor-based platform that is connected to a network and that interacts with one or more application programs and may operate on any suitable operating system. Server devices may also be coupled to the network and, similarly to client devices, such server devices may comprise a processor coupled to a computer-readable medium, such as a random access memory (RAM). Such server devices, which may be a single computer system, may also be implemented as a network of computer processors. Examples of such server devices are servers, mainframe computers, networked computers, a processor-based device, and similar types of systems and devices

1. A method for managing communication streams from multiple sources while utilizing a single short code, comprising:
establishing, using a processor coupled to memory, a plurality of conversation sessions using a same short code and at least in part concurrently, each with an outbound message to a recipient;
defining, using the processor, a lifespan of the outbound message of each of the plurality of conversation sessions; and
delivering, using the processor, at least one reply to a response from the recipient to the outbound message of at least one of the conversation sessions during the lifespan of the outbound message of the at least one of the plurality of conversation sessions.

2. The method of claim 1, further comprising establishing an outbound communication state for each of said plurality of conversation sessions.

3. The method of claim 1, wherein defining said lifespan of the outbound message of each of the plurality of conversation sessions further comprises defining a period of time within which information in each of the respective outbound messages is relevant to a corresponding one of the plurality of conversation sessions.

4. The method of claim 1, wherein delivering said at least one reply to the response further comprises delivering a default reply to the response to the outbound message of said at least one of the conversation sessions after the lifespan of the outbound message of said at least one of the conversation sessions.

5. The method of claim 1, further comprising establishing an outbound communication state for each of the plurality of conversation sessions.

6. The method of claim 5, further comprising tracking a last established one of said outbound communication states.

7. The method of claim 6, wherein tracking said last established one of the outbound communication states further comprises establishing an outbound communication state of a last one of the outbound conversation sessions and breaking an outbound communication state of a preceding conversation session.

8. The method of claim 7, further comprising delivering said reply to the response to the outbound message based upon a source of the last established one of the outbound communication states.

9. The method of claim 1, wherein establishing said plurality of conversation sessions further comprises establishing a plurality of concurrent conversation sessions with the recipient and a concurrent outbound communication state for each of the plurality of concurrent conversation sessions.

10. The method of claim 9, further comprising delivering said reply to the response to the outbound message of one of the plurality of concurrent conversation sessions during the lifespan of all of the outbound messages of the plurality of concurrent conversation sessions with a request for a further response indicating a choice by the recipient of one of the plurality of concurrent conversation sessions to which the response to the outbound message relates.

11. The method of claim 1, further comprising identifying by an interface with a payment utility an account utilized by said recipient for a previous payment via the payment utility.

12. The method of claim 11, further comprising establishing at least one of the plurality of conversation sessions with a corresponding one of the outbound messages to the recipient inviting the recipient to authorize a current payment from the identified account via the payment utility.

13. The method of claim 12, further comprising receiving a response from the recipient to said outbound message authorizing the current payment from the identified account via the payment utility.

14. The method of claim 13, further comprising processing the current payment by the interface to the payment utility.

15. The method of claim 14, further comprising delivering said at least one reply to the response to the outbound message of the at least one conversation session confirming the current payment.

16. The method of claim 1, wherein establishing said at plurality of conversation sessions further comprises establishing at least one conversation session with the outbound message to the recipient requesting the recipient to authenticate a financial transaction.

17. The method of claim 16, further comprising receiving a response to the outbound message authenticating the financial transaction.

18. The method of claim 17, wherein delivering said at least one reply further comprises delivering the at least one reply to the response to the outbound message of the at least one conversation session authorizing the financial transaction.

19. A system for managing communication streams from multiple sources while utilizing a single short code, comprising:
establish a plurality of conversation sessions using a same short code and at least in part concurrently, each with an outbound message to a recipient;
define a lifespan of the outbound message of each of the plurality of conversation sessions; and
deliver at least one reply to a response from the recipient to the outbound message of at least one of the conversation sessions during the lifespan of the outbound message of the at least one of the plurality of conversation sessions.

20. A non-transitory computer-readable storage medium with an executable program stored thereon, wherein the program instructs a microprocessor to perform the following steps:
establishing a plurality of conversation sessions using a same short code and at least in part concurrently, each with an outbound message to a recipient:
defining a lifespan of the outbound message of each of the plurality of conversation sessions; and
delivering at least one reply to a response from the recipient to the outbound message of at least one of the conversation sessions during the lifespan of the outbound message of the at least one of the plurality of conversation sessions.
